(19) United States
(12) Patent Application Publication
(10) Pub. No.: US 2023/0007035 A1
(43) Pub. Date: Jan. 5, 2023

(54) METHOD OF DETECTING ANOMALIES IN A BLOCKCHAIN NETWORK AND BLOCKCHAIN NETWORK IMPLEMENTING SUCH A METHOD

(71) Applicant: BULL SAS, Les Clayes-sous-Bois (FR)

(72) Inventors: David LEPORINI, RUNGIS (FR); Guillaume HEBERT, LYON (FR); Antoine DURAND, MASSY (FR)

(73) Assignee: BULL SAS, Les Clayes-sous-Bois (FR)

(21) Appl. No.: 17/858,029

(22) Filed: Jul. 5, 2022

(30) Foreign Application Priority Data
Jul. 5, 2021 (EP) 21305930.6

(51) Int. Cl. H04L 9/40

(52) U.S. Cl. CPC H04L 63/1425

(57) ABSTRACT

Embodiments include a method of detecting anomalies within a blockchain network including a plurality of nodes, the method including for at a measured node, of the blockchain network, measuring at least one operational parameter of the measured node. The method also includes injecting at least one measured value of at least one operational parameter into at least one predetermined heuristic model signaling a possible anomaly within the blockchain network based on the at least one measured value. Embodiments also include a computer program including computer instructions, which, when they are executed by a computer device, implement the method. Embodiments also include a block chain network configured to implement the method of detecting anomalies.

The present invention relates to a method of detecting anomaly(ies) within a blockchain network. It also relates to a blockchain network implementing said anomaly detection method.

The field of the invention is the field of blockchain networks, in particular the field of detecting an anomaly within a blockchain network.

### STATE OF THE ART

Blockchain protocols, whether open or closed, are known for the level of security they guarantee to a network, on the security as well as reactivity level of said blockchain network.

In spite of the high level of security of blockchain protocols, blockchain networks nonetheless remain favorite targets of cyberattacks.

There are different techniques for improving the security within a blockchain network, thus enabling a better defense when faced with a possible cyberattack. For example, the cryptography of the private keys can be reinforced, or cold wallets can be used to store such private keys off-line.

These solutions, provided upstream, make it possible to increase the security of each node of the blockchain network at the security protocol level implemented in the blockchain network, but does not enable an attack in progress on the blockchain network to be detected. There is currently no solution enabling detection of an attack in progress within a blockchain network.

Currently, it is particularly impossible to detect an attack exploiting limitations or constraints related to the security protocol itself. For example, it is impossible to detect an attack seeking to slow the transmission of messages within the network when the security protocol depends on good synchronization of the data within said network.

Moreover, it is also currently impossible to detect an eclipse type attack seeking to isolate one or more nodes from the rest of the blockchain network.

One aim of the present invention is to solve at least one of the above-mentioned shortcomings.

Another purpose of the present invention is to propose a method of detecting attacks exploiting limitations or constraints related to the security model of a blockchain network.

Another purpose of the present invention is to propose a method of detecting eclipse type attacks.

Another purpose of the present invention is to propose a detection method easy to implement in a blockchain network.

### DISCLOSURE OF THE INVENTION

The invention makes it possible to achieve at least one of these purposes by a method of detecting anomaly(ies) within a blockchain network comprising a plurality of nodes, said method comprising at least one iteration of the following steps:

for at least one node, called measured node, of said network, measuring at least one operational parameter of said measured node; and

injecting said at least one measured value of at least one operational parameter into at least one predetermined heuristic model signaling a possible anomaly within said blockchain network based on said at least one measured value.

Thus, the invention proposes a method making it possible to detect an anomaly occurring within a blockchain network from a measurement of a value of at least one operational parameter from at least one node of the network. Because the operation of at least one node of the blockchain network is disturbed during a cyberattack, it is possible with the method according to the invention to detect an anomaly symptomatic of a cyberattack by injecting the measured value of an operational parameter into a predetermined heuristic model in order to detect this anomaly.

Thus, the method according to the invention is capable of detecting an attack in progress exploiting limitations or constraints related to the security protocol of a network by measuring at least one of the operational parameters impacted by said attack. For example, by measuring the latency of communications of one node with at least one other node of the network, then by injecting the measured value of this latency into a heuristic model, it is possible to detect an abnormal latency and therefore to detect an attack in progress seeking to slow the transmission of messages within the blockchain network.

Furthermore, it is possible with the method according to the invention to detect an eclipse type attack, for example by measuring the communication topology of at least one node, that is, with which other nodes of the network said node is communicating. In effect, an eclipse attack against a node of the network seeks to isolate that node from the rest of the blockchain network, which involves a communication topology change of that node of the blockchain network.

In an entirely non-limiting way, for at least one node, at least one measured operational parameter may for example be:

a communication latency of one node with at least another node of the network,

a communication topology of a node, that is, with which other nodes of the network the measured node communicates

a data from the internal clock of the node,

a local representation status of the node,

a sending quality, and

ownership of the “fragments” of the blockchain,

Etc. . . .

Moreover, the detection method according to the invention is easy to implement in a blockchain network because the method requires measuring one or more operational parameters and injecting said measured value into a predetermined heuristic model in order to detect an anomaly.

Advantageously, at least one measured node can be a real node of the blockchain network.

The term “real node” is understood as a node of the blockchain network participating in creating new blocks within the blockchain network.

The method according to the invention thus enables monitoring the operation of the blockchain network and detecting possible anomalies, by measuring at least one operational parameter directly at a real node of the blockchain network, that is, a node participating in creating and adding new blocks in the chain of blocks.

Thus, the method according to the invention may be implemented in any active blockchain network.

Alternatively or in addition, at least one measured node can be a decoy node deployed within the blockchain network.

The term “decoy node” is understood as a node not participating in creating and/or adding new blocks into the chain of blocks.

Such a decoy node not participating in the creation of new blocks of the blockchain may be deployed within any blockchain network in order to measure at least one of its operational parameters. Thus, the method according to the invention enables the monitoring of the operation of a blockchain network and detecting of possible anomalies without intervention on the real nodes forming the blockchain network, that is, on the nodes participating in the blockchain protocol within the blockchain network.

According to one embodiment, the measurement of the operational parameter of a measured node may be carried out by said measured node, for example by an application tool deployed within said node. The measurement of the operational parameter may also be carried out by a processor or by an administration tool of said decoy node, or by an operating system of said measured node.

Alternatively, or in addition, the measurement of the at least one operational parameter of at least one measured node may be carried out by device external to said measured node. In this case, said measured node is configured to authorize an external device to carry out this measurement, and in particular to access variables within said measured node, for example variables stored within an internal log of said measured node.

When the measured node is a decoy node, said measured node may be configured to record in an internal log a more precise sampling of the operational parameters, compared to a real node of the network. The measurement of at least one operational parameter of such a decoy node may thus be carried out more precisely and improve the precision or sensitivity of the anomaly detection within the blockchain network.

Alternatively or in addition, when the measured node is a decoy node, said decoy node may be configured to record in an internal log other operational parameters, different from those recorded by a real node of the blockchain network. Thus, it is possible to carry out a measurement of operational parameters that cannot be measured within the context of a real node, which enables the detection of a greater variety of anomalies, or of fewer anomalies that could be detected with real nodes.

Advantageously, the injection step may be implemented at a decoy node deployed within the blockchain network.

When the measured node is not said decoy node carrying out the injection step, the method according to the invention may comprise a step of transmission from said measured node of at least one measured value to said decoy node. This transmission may be a specific transmission comprising only measured data. In this case, at least one value may be transmitted within a dedicated transaction or a specific one between the measured node and the decoy node.

Alternatively or in addition, at least one measured data may be transmitted jointly to a transaction between the measured node and the node carrying out the injection step. More particularly, the measured node may transmit at least one measured data jointly to each transaction with the node carrying out the injection step.

The implementation of the injection step at a decoy node makes it possible to have greater detection security because it is possible to implement a plurality of decoy nodes in such a way that when one of the decoy nodes is the object of an attack, another decoy node may take the relays. Moreover, the fact of implementing the injection step at a decoy makes it possible not to modify the operation of a real node.

Alternatively, the injection step may be implemented at a module, called central, the method further comprising a step of transmitting at least one measured value to said central module.

Thus, it is possible for the method according to the invention to implement the injection step at a module, which does not constitute a node of the blockchain network in the sense of a real node or a decoy node. This makes it possible to completely dissociate the nodes of the network from the central module responsible for detecting anomalies within the blockchain network.

Advantageously, and as indicated herein above, the measured value of at least one operational parameter of a measured node may be read in an operational log of said measured node.

For example, this value may be read by the measured node itself, whether a decoy node or a real node.

Alternatively, for a measured node, this value may be read by a central module or a decoy node, other than the measured node, in particular when the injection step is carried out by said decoy node or said central module.

For example, the value of at least one parameter may be either:
read directly in the measured node by said decoy node or said central module,
or transmitted, alone or with a portion or all of the log, to the central module or to the decoy node.

Such a transmission of the measured value or of the log may be done either automatically by the measured node or upon request from the central module or from the decoy node.

Advantageously, at least one, in particular each, communication related to the implementation of the method may be encrypted.

Thus, each transmission of log or of measured value of a parameter, or each request by a decoy node or central module, may be carried out in an encrypted manner.

Thus, the data thus exchanged cannot be easily intercepted and/or manipulated by an entity wishing to carry out a cyberattack.

Alternatively or in addition, the exchanges for the implementation of the method according to the invention may be carried out through dedicated communication channels, in order to secure said exchanges.

Advantageously, at least one heuristic model may be provided in order to compare at least one injected measured value to at least one predefined threshold value.

Thus, it is possible to detect an anomaly by comparison of a measured value to a predefined threshold value, in a way that is simple without using complex models.

Alternatively, at least one heuristic model may be, or may comprise, a neuronal network previously trained to detect at least one anomaly from at least one value of an operational parameter that is provided to it.

Thus, the method according to the invention makes it possible to detect attacks for which the symptoms are more complex and depend on the value of several operational parameters. The method according to the invention makes it possible to carry out a more complete detection of anomalies, particularly of anomalies symptomatic of a cyberattack and therefore less susceptible to generating false positives.

Moreover, in order to further improve the anomaly detection precision of the method according to the invention, it is possible to use a neuronal network previously trained to signal a possible anomaly based on a plurality of measured operational parameters:

that are different, and/or

are carried out within different nodes of the network.

Advantageously, the method according to the invention may comprise a step of sending an alert message when the injection step signals an anomaly.

The alert may be sent only to the node concerned by the anomaly.

Alternatively, the alert may be sent to all the nodes of the blockchain network that are not concerned by the anomaly.

According to another alternative, the alert may be sent to all the nodes of the blockchain network.

Thus, each node receiving an alert message may implement defense procedures predefined in the blockchain protocol, such as for example stopping all communication within the network.

Furthermore, when the injection step signals an anomaly, the method according to the invention may comprise an incident response step comprising execution of any combination of at least one of the following measures:

excluding certain nodes that have a Byzantine behavior,

suspending the protocol for the time to make a report and prevent forging corrupt blocks,

updating the protocol via a consensus.

These measures may be predefined in the blockchain protocol.

The incident response step may be carried out at the same time or after the step of sending an alert message.

According to another aspect of the invention, a computer program is proposed comprising computer instructions, which, when they are executed by a computer device, implement the method according to the invention.

According to another aspect of the invention, a blockchain network is proposed comprising a plurality of nodes, configured to implement the method according to the invention.

Advantageously, the network may comprise at least one decoy node.

Such a decoy node may be used as measured node and/or may be configured to implement the injection step, as described hereinabove.

Alternatively or in addition, the network may comprise a central module, provided for implementing the injection step. This makes it possible to completely dissociate the nodes of the network from the central module responsible for detecting anomalies within the blockchain network.

### DESCRIPTION OF FIGURES AND EMBODIMENTS

Other benefits and features will become evident upon examining the detailed description of an entirely non-limiting embodiment, and from the enclosed drawings in which:

FIG. 1 is a schematic representation of an entirely non-limiting exemplary embodiment of a method according to the invention;

FIG. 2 is a schematic representation of another entirely non-limiting exemplary embodiment of a method according to the invention;

FIG. 3 is a schematic representation of an entirely non-limiting exemplary embodiment of a blockchain network according to the invention;

FIG. 4 is a schematic representation of another entirely non-limiting exemplary embodiment of a blockchain network according to the invention;

FIG. 5 is a schematic representation of another entirely non-limiting exemplary embodiment of a blockchain network according to the invention; and

FIG. 6 is a schematic representation of another non-limiting exemplary embodiment of a blockchain network according to the invention.

It is understood that the embodiments disclosed hereunder are by no means limiting. In particular, it is possible to imagine variants of the invention that comprise only a selection of the features disclosed hereinafter in isolation from the other features disclosed, if this selection of features is sufficient to confer a technical benefit or to differentiate the invention with respect to the prior state of the art. This selection comprises at least one preferably functional feature which lacks structural details, or only has a portion of the structural details if that portion is only sufficient to confer a technical benefit or to differentiate the invention with respect to the prior state of the art.

In the figures the same reference has been used for the elements that are common to several figures.

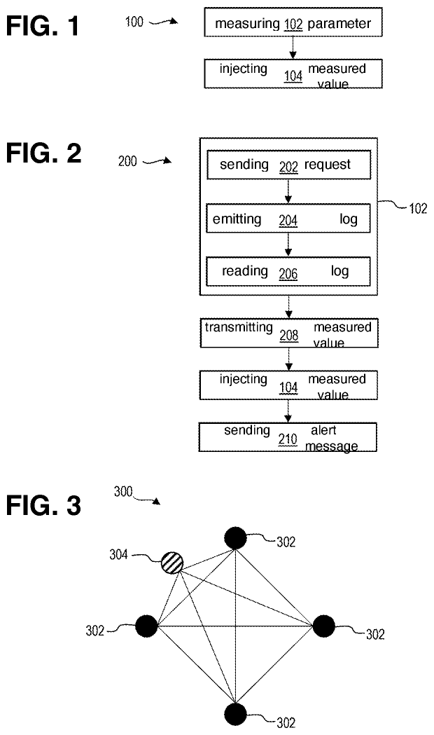

FIG. 1 is a schematic representation of an entirely non-limiting exemplary embodiment of a method according to the invention.

The method 100 of FIG. 1 is a method of detecting an anomaly within a blockchain network comprising a plurality of nodes.

The method 100 comprises a step 102 of measuring at least one operational parameter of at least one node, called measured node, of the blockchain network.

At least one node measured in step 102 may be a real node of the blockchain network, that is, a node participating in creating new blocks of the blockchain.

Alternatively or in addition, at least one node measured during step 102 may be a decoy node, deployed within the blockchain network, but not participating in creating new blocks of the blockchain.

In an entirely non-limiting way, for at least one node, the at least one operational parameter measured in step 102 may for example be or comprise:

a communication latency of one node with at least another node of the network,

a communication topology of a node, that is, with which other nodes of the network the measured node communicates,

a data from the internal clock of the node,

a local representation status of the node,

a sending quality,

ownership of the “fragments” of the blockchain,

etc. . . .

The method 100 further comprises, after the measuring step 102, a step 104 of injecting said at least one measured value of at least one operational parameter into a predetermined heuristic model signaling a possible anomaly within said blockchain network based on said at least one measured value.

Because the operation of at least one node of the blockchain network is disturbed during a cyberattack, it is therefore possible with the method 100 to detect an anomaly symptomatic of a cyberattack by injecting into a predetermined heuristic model, during step 104, at least one value of an operational parameter measured during step 102.

The heuristic model may for example be provided to compare at least one measured value to at least one predefined threshold.

Alternatively, the heuristic model may for example be or comprise a neuronal network previously trained to detect anomalies.

The injection step 104 may for example be implemented at a decoy node deployed within the blockchain network but not participating in creating new blocks of the blockchain.

The measuring step 102 and injection step 104 may for example be implemented at the same decoy node.

According to another example, the injection step 104 may be implemented at the central module of the blockchain network but which does not form a node of the blockchain network.

FIG. 2 is a schematic representation of another entirely non-limiting exemplary embodiment of a method according to the invention.

The method 200 comprises all the steps of the method 100 described in relation to FIG. 1.

In the method 200 of FIG. 2, the measuring step 102 of measuring at least one operational parameter of at least one measured node comprises the following steps:

a step 202 of sending, by a decoy node of the network to a measured node, a request to send at least a portion of its operational log,

a step 204 of emitting said at least a portion of the operational log by the measured node to the decoy node, in response to the request, and

a step 206 of reading at least a portion of the operational log.

The measured node may for example be a real node or a decoy node different from the one sending the request.

The method 200 further comprises, after the measuring step 102 and before the injection step 104 a step 208 of transmitting, to a central module of the blockchain network, at least one value measured during step 102.

In this exemplary embodiment, the step 104 of injecting at least one measured value into a heuristic model is carried out at said central module.

The method 200 further comprises, when an anomaly is signaled by the heuristic model, a step 208 of sending an alert message to each of the nodes of the network or only to the node concerned by the anomaly.

According to an alternative embodiment, the measured node, preferably a decoy node, may be configured to emit automatically and at a given frequency at least a portion of its operational log to the decoy node responsible for the reading. In this case, the step 202 of sending a request is not necessary and therefore not carried out.

According to another alternative embodiment, the measuring of at least one operational parameter of a measured node may be implemented by the node itself. Thus, neither the sending of a request nor the emission of at least a portion of the log is required to read said log during the step. In this case, neither step 202 of sending a request nor step 204 of emitting at least a portion of the log are carried out.

According to still another alternative embodiment, the injection of at least one measured value of at least one operational parameter into a heuristic model may be carried out at the measured decoy node. In this case, neither step 202 of sending a request, nor step 204 of emitting at least a portion of the log, nor the transmission step 208 are carried out.

FIG. 3 is a schematic representation of an entirely non-limiting exemplary embodiment of a blockchain network according to the invention.

FIG. 3 shows a blockchain network 300 configured to implement the method 100 described in relation to FIG. 1, and more generally a method according to the invention.

In the example represented, the network 300 comprises four real nodes 302 and one decoy node 304.

For reasons of readability, the number of real nodes 302 shown in FIG. 3 is four. However, it will seem obvious that a blockchain network may comprise a number of real nodes other than four.

Again in the example of FIG. 3, all the nodes 302, 304 are in communication with one another. However, depending on the blockchain protocol used and depending on the number of nodes of the blockchain network, it is possible that all the nodes of the blockchain network are not in communication with one another.

According to one exemplary embodiment, each node of the network 300 may be a measured node. Thus, a value of at least one operational parameter may be measured during the measuring step, for each real node 302 and the decoy node 304.

Again according to one exemplary embodiment, the injection step, and in particular step 104, may be carried out in the decoy node 304. In this case, each real node 302 communicates the value of the measured parameter(s) to the decoy node, either in an automated manner at a given frequency, or upon request from the decoy node 304. Thus, the decoy node 304 receives the values of the operational parameters of all the real nodes 302 of the network 300. It also has values of its own operational parameters. Thus, it may carry out an anomaly detection by injecting these measured values into a heuristic model, together or separately.

The injection of the values into a heuristic model may be carried out for each measured node individually.

Alternatively, the injection of the values into a heuristic model may be carried out individually for each operational parameter. In this case, it is possible to inject together several measured values of this operational parameter at several measured nodes. For example, it is possible to inject the communication topology of several measured nodes into a heuristic model in order to detect if one of these measured nodes has an anomaly.

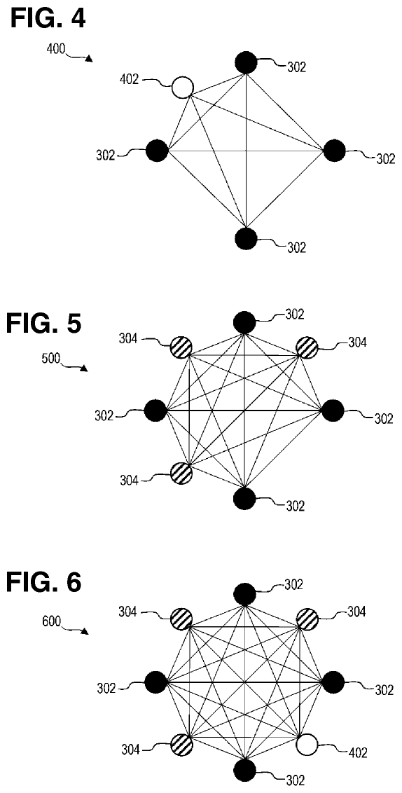

FIG. 4 is a schematic representation of another entirely non-limiting exemplary embodiment of a blockchain network according to the invention.

The blockchain network 400 shown in FIG. 4 differs from the network 300 shown in FIG. 3 in that the decoy node 304 is replaced by a central module 402. The central module 402 is in communication with each of the nodes 302 of the network 400. However, contrary to a decoy node 304, the central module 402 does not act as a node within the network 400 in the sense of a real node or a decoy node.

According to one exemplary embodiment, each real node of the network 400 can be measured. Thus, a value of at least one operational parameter may be measured during the measuring step, for each real node 302.

Still in accordance with one exemplary embodiment, the injection step, and in particular step 104, may be carried out in the central module 402. In this case, each real node 302 communicates the value of the measured parameter(s) to the central module 402, either in an automated manner at a given frequency, or upon request from the central module 402. Thus, central module 402 receives the values of the operational parameters of all the real nodes 302 of the network 400. Thus, it may carry out an anomaly detection by injecting these measured values into a heuristic model, together or separately.

FIG. 5 is a schematic representation of another non-limiting exemplary embodiment of a blockchain network according to the invention.

The blockchain network 500 shown in FIG. 5 comprises all the elements of the network 300 of FIG. 3.

The network 500 further comprises two other decoy nodes 304. All the nodes 302, 304 are in communication with one another.

According to one exemplary embodiment, each node 302 and 304 of the network 500 may be a measured node. Thus, a value of at least one operational parameter may be measured during the measuring step, for each real node 302 and each decoy node 304.

Still in accordance with one exemplary embodiment, the injection step, and in particular step 104, may be carried out in any of the decoy nodes 304.

In this case, the decoy node 304 at which the injection step is implemented may receive the values of the operational parameters from all the other nodes of the network, real 302 and decoy 304.

It also has values of its own operational parameters. Thus, it may carry out an anomaly detection by injecting these measured values into a heuristic model, together or separately.

FIG. 6 is a schematic representation of another non-limiting exemplary embodiment of a blockchain network according to the invention.

The blockchain network 600 shown in FIG. 6 comprises all the elements of the network 500 of FIG. 5.

The network 600 further comprises a central module 402 in communication with each of the real nodes 302 and decoy nodes 304.

According to one exemplary embodiment, each node 302 and 304 of the network 600 may be a measured node. Thus, a value of at least one operational parameter may be measured during the measuring step, for each real node 302 and each decoy node 304.

Still in accordance with one exemplary embodiment, the injection step, and in particular step 104, may be carried out in the central module 402.

In this case, each real node 302 and each decoy node communicates the value of the measured parameter(s) to the central module 402, either in an automated manner at a given frequency, or upon request from the central module 402. Thus, the central module 402 receives the values of the functional parameters of all the real nodes 302 and decoy nodes 304 of the network 600. Thus, it may carry out an anomaly detection by injecting these measured values into a heuristic model, together or separately.

Of course, the invention is not limited to the examples detailed above.

1. A method of detecting anomalies within a blockchain network comprising a plurality of nodes, said method comprising:
for at least one node of said plurality of nodes, said at least one node comprising at least one measured node of said blockchain network, measuring at least one operational parameter of said at least one measured node; and
injecting at least one measured value of said at least one operational parameter that is measured into a predetermined heuristic model signaling a possible anomaly within said blockchain network based on said at least one measured value.

2. The method according to claim 1, wherein said at least one measured node is a real node of the blockchain network.

3. The method according to claim 1, wherein said at least one measured node is a decoy node deployed within the blockchain network.

4. The method according to claim 1, wherein said injecting said at least one measured value is implemented at a decoy node deployed within the blockchain network.

5. The method according to claim 1, wherein said injecting said at least one measured value is implemented at a central module, and wherein the method further comprises transmitting said at least one measured value to said central module.

6. The method according to claim 1, wherein the at least one measured value of said at least one operational parameter of said at least one measured node is read in an operational log of said at least one measured node.

7. The method according to claim 1, wherein at least one communication relative to implementation of the method is encrypted.

8. The method according to claim 1, wherein said predetermined heuristic model comprises at least one heuristic model that is provided for comparing said at least one measured value that is injected to at least one predefined threshold value.

9. The method according to claim 1, wherein said predetermined heuristic model comprises at least one heuristic model that comprises a neuronal network previously trained to detect at least one anomaly from at least one value of an operational parameter that is provided to it.

10. The method according to claim 1, further comprising sending an alert message when said injecting said at least one measured value signals an anomaly.

11. The method according to claim 10, wherein, when said injecting said at least one measured value signals said anomaly, said method further comprises an incident response step comprising executing any combination of at least one of
excluding certain nodes that have a Byzantine behavior,
suspending a protocol for a time to make a report and prevent forging corrupt blocks,
updating the protocol via a consensus.

12. A computer program comprising computer instructions, which, when executed by a computer device, implement a method of detecting anomalies within a blockchain network comprising a plurality of nodes, said method comprising:
for at least one node of said plurality of nodes, said at least one node comprising at least one measured node of said blockchain network, measuring at least one operational parameter of said at least one measured node; and
injecting at least one measured value of said at least one operational parameter that is measured into a predetermined heuristic model signaling a possible anomaly within said blockchain network based on said at least one measured value.

13. A blockchain network comprising:
a plurality of nodes, configured to implement a method of detecting anomalies within said blockchain network, said method comprising
for at least one node of said plurality of nodes, said at least one node comprising at least one measured node of said blockchain network, measuring at least one operational parameter of said at least one measured node; and
injecting at least one measured value of said at least one operational parameter that is measured into a predetermined heuristic model signaling a possible anomaly within said blockchain network based on said at least one measured value.

14. The blockchain network according to claim 13, wherein said at least one node comprises at least one decoy node.

15. The blockchain network according to claim 13, further comprising a central module.
